(19) United States
(12) Patent Application Publication
(10) Pub. No.: US 2017/0022944 A1
(43) Pub. Date: Jan. 26, 2017

(54) EXHAUST FLAP DEVICE FOR AN INTERNAL COMBUSTION ENGINE

(71) Applicant: PIERBURG GMBH, NEUSS (DE)

(72) Inventors: HANS GERARDS, GANGELT (DE); ANDREAS GRAUTEN, KREFELD (DE); JUERGEN MICHELS, MOENCHENGLADBACH (DE); TIM HOLLER, TOENISVORST (DE); KIRILL KLASS, ESSEN (DE)

(73) Assignee: PIERBURG GMBH, NEUSS (DE)

(21) Appl. No.: 15/300,784

(22) PCT Filed: Feb. 19, 2015
(86) PCT No.: PCT/EP2015/053474

§ 371 Date: Sep. 30, 2016

(30) Foreign Application Priority Data
Apr. 1, 2014 (DE) 10 2014 104 577.7

(51) Int. Cl. F02M 26/70; F02M 26/73; F02D 9/10; F16K 31/04; F02M 26/54; F02D 9/04

(52) U.S. Cl. CPC F02M 26/70; F02M 26/54; F02D 9/04; F02D 9/106; F02D 9/1065; F16K 31/043; F02M 26/73

(57) ABSTRACT

An exhaust flap device for an internal combustion engine includes a flow housing with a bearing seat, the flow housing delimiting an exhaust duct, a rotating shaft with a thermal conductivity of λ<17 W/mK, a flap body attached to the shaft in the exhaust duct, an electrical actuator with an electric motor and a gearing which has an output gear fixed on the shaft on which the flap body is arranged, an actuator housing having the actuator be arranged therein, and a first bearing with a thermal conductivity of λ>17 W/mK arranged in the bearing seat of the flow housing. The electrical actuator rotates the shaft and thereby the flap body in the exhaust duct. The shaft protrudes into the actuator housing. An inner circumference of the bearing seat corresponds to an outer circumference of the first bearing.

### CROSS REFERENCE TO PRIOR APPLICATIONS

This application is a U.S. National Phase application under 35 U.S.C. §371 of International Application No. PCT/EP2015/053474, filed on Feb. 19, 2015 and which claims benefit to German Patent Application No. 10 2014 104 577.7, filed on Apr. 1, 2014. The International Application was published in German on Oct. 8, 2015 as WO 2015/149990 A1 under PCT Article 21(2).

### FIELD

The present invention relates to an exhaust flap device for an internal combustion engine, the exhaust flap device comprising a flow housing which delimits an exhaust duct, a flap body which is rotatably arranged in the exhaust duct, a shaft on which the flap body is fixed, an electrical actuator having an electric motor and a gearing via which the shaft and the flap body can be rotated in the exhaust duct, and an actuator housing in which the actuator is arranged, wherein the shaft protrudes into the actuator housing.

### BACKGROUND

Such exhaust flap devices are used either as exhaust retention flaps or as exhaust recirculation valves in low pressure or high pressure exhaust circuits of internal combustion engines. They serve to control a quantity of exhaust gas to be recirculated to the cylinders or to control the pressure in the exhaust recirculation duct to reduce the pollutant emissions of the engine.

These valves are subjected to different loads both with respect to the incidental quantity of pollutants and the temperatures prevailing depending on the installation position. In particular in the case of valves arranged in the hot gas region, i.e., in the exhaust outlet region or the high pressure exhaust recirculation duct upstream of any existing exhaust cooler, a thermal load must be expected that is so high that if an electric motor is used to drive the flaps, the motor must be protected from overheating.

This is achieved either by arranging the actuator at a greater distance from the exhaust duct and by operating it via a linkage, or at least by separating the flap shaft from the output shaft of the actuator and by merely providing a coupling between the two shafts via coupling elements with poor conductivity.

DE 10 2011 000 101 A1 describes a further measure to protect against the thermal overload of an electric motor. DE 10 2011 000 101 A1 describes manufacturing an actuator housing from at least two housing parts of different thermal conductivities. The housing part having poor thermal conductivity is directed towards the exhaust duct, and the housing part having good thermal conductivity is arranged to be averted from the exhaust duct and is provided with ribs via which a maximum possible quantity of heat can be dissipated into the environment. The electric motor in this arrangement is, however, still positioned in the immediate vicinity of the exhaust duct so that a thermal overload of the electric motor must be expected if the electric motor is used at high temperatures for longer periods of time.

An exhaust recirculation valve is also described in EP 2 597 294 A2 which is used in the low pressure exhaust recirculation region, i.e., at lower incidental temperatures. The flap body with this valve is arranged directly on the output shaft of the electric motor. This results in a high heat input into the electric motor so that damage caused by overheating is very likely.

The known designs are therefore disadvantageous in that they provide insufficient protection against thermal overload if the actuator is arranged in the vicinity of the exhaust duct and if the shaft, on which the flap body is arranged, protrudes into the actuator housing.

### SUMMARY

An aspect of the present invention is to provide a flap device for an internal combustion engine which can be subjected to high thermal loads while at the same time having a simple structure with an integral flap shaft extending into the actuator housing so that an overheating of the electric motor is reliably avoided even in regions under high thermal load.

In an embodiment, the present invention provides an exhaust flap device for an internal combustion engine which includes a flow housing comprising a bearing seat, the flow housing being configured to delimit an exhaust duct, a shaft which is configured to rotate comprising a thermal conductivity of λ<17 W/mK, a flap body attached to the shaft in the exhaust duct, an electrical actuator comprising an electric motor and a gearing which comprises an output gear fixed on the shaft on which the flap body is arranged, an actuator housing configured to have the actuator be arranged therein, and a first bearing comprising a thermal conductivity of λ>17 W/mK arranged in the bearing seat of the flow housing. The electrical actuator is configured to rotate the shaft and thereby the flap body in the exhaust duct. The shaft is configured to protrude into the actuator housing. An inner circumference of the bearing seat corresponds to an outer circumference of the first bearing.

### BRIEF DESCRIPTION OF THE DRAWINGS

The present invention is described in greater detail below on the basis of embodiments and of the drawings in which:

FIG. 1 shows a side view of a first embodiment of a flap device of the present invention in section; and

FIG. 2 shows a sectional view of a second embodiment of an exhaust flap device rotated by 90° with respect to the first embodiment.

### DETAILED DESCRIPTION

Because an output gear of the gearing is fastened on the shaft on which the flap body is arranged and the shaft has a thermal conductivity of λ<17 W/mK and is arranged in a bearing having a thermal conductivity of λ<17 W/mK and is arranged in a bearing seat of the flow housing, wherein the inner circumference of the bearing seat corresponds to the outer circumference of the bearing, the heat input into the actuator housing via the shaft is reduced and an increased heat dissipation is achieved via the bearing and the bearing seat of the flow housing due to the large contact surface between the bearing and the bearing seat of the flow housing so that the first bearing acts as a heat sink. A direct connection of the flap shaft with the actuator is nonetheless made without having to use intermediate coupling elements.

In an embodiment of the present invention, the actuator housing can, for example, have a thermal conductivity of λ>150 W/mK. It is thereby provided that a great quantity of heat can be dissipated into the environment via the large surface of the actuator housing.

The actuator housing can, for example, be made of an aluminum alloy which provides a sufficient thermal conduction.

In an embodiment of the present invention, the shaft can, for example, be made of an austenitic steel which can be produced at low cost and which allows for a low thermal conduction into the actuator housing via the shaft.

In an embodiment of the present invention, the first bearing can, for example, be a carbon graphite bearing which has very good sliding properties even at high temperatures and, at a thermal conductivity of about 65 W/mK, results in high thermal dissipation from the shaft towards the surrounding housing so that a considerable quantity of heat can be dissipated before it reaches the actuator housing.

In an embodiment of the present invention, the bearing seat of the flow housing can, for example, protrude into a receiving opening of the actuator housing and abut radially against walls that radially delimit the receiving opening. The bearing seat of the flow housing may, for example, protrude into the receiving opening of the actuator housing, wherein the outer circumference of the bearing housing corresponds to the inner circumference of the receiving opening of the actuator housing, whereby the thermally conductive connection is made from the region of the bearing seat of the flow housing to the heat dissipating actuator housing.

In an embodiment of the present invention, a second bearing having a thermal conductivity λ>17 W/mK can, for example, be arranged in the receiving opening of the actuator housing, the shaft being arranged in this bearing, with the outer circumference of the second bearing being in contact with the actuator housing. The second bearing thereby also acts as a heat sink, and the heat transmitted via the shaft is directed towards the actuator housing and thus towards the environment.

A sealing ring surrounding the shaft is arranged axially in the receiving opening on the side of the second bearing averted from the flap body to additionally prevent hot exhaust gas from being introduced into the interior of the actuator housing between the shaft and the bearing.

In an embodiment of the present invention, a bearing bushing can, for example, be arranged in the receiving opening of the actuator housing as an axial bearing with a thermal conductivity of λ>17 W/mK, which bearing surrounds the shaft, wherein the outer circumference of the bearing bushing contacts the actuator housing to establish a thermally conductive contact with the actuator housing which allows heat from the shaft and from the exhaust gas flowing along the shaft to be dissipated into the environment. The bearing bushing further causes a preliminary sealing for minimizing the gas flow towards the second radial bearing.

A radial bearing realized as a needle bearing with radial sealing rings may be arranged in the receiving bore in such a design, which bearing surrounds the shaft, wherein the bearing bushing is arranged axially between the flap body and the needle bearing. The needle bearing thereby provides a good sealing of the shaft due to the integrated sealing rings and provides good radial support with a high load capacity.

In an embodiment of the present invention, outward directed cooling ribs can, for example, be formed on the bearing housing, whereby, due to the increased surface, the dissipation of heat into the environment is further increased so that a heat transfer towards the electric motor is significantly reduced.

In an embodiment of the present invention, a heat dissipation sheet can, for example, be arranged between the electric motor and the flow housing. This prevents the housing surrounding the electric motor from being heated up by thermal radiation from the flow housing.

In an embodiment of the present invention, a thrust washer can, for example, be fastened on the shaft, which thrust washer is pre-loaded against the first bearing or the bearing bushing by a compression spring. The thrust washer is fixedly fastened on the shaft and, together with the spring, provides an axial positional fixation of the shaft and thus of the flap in the duct. By the contact with the bearing bushing or the slide bearing, the thermal contact with these components is further increased. An increased heat dissipation and a preliminary sealing in the direction of the second bearing are thereby achieved.

An exhaust flap for an internal combustion engine is thus provided which may be used in a hot gas region without requiring a separation of the actuator shaft from the flap shaft or having to arrange the actuator at a great distance from the flow housing. The heat input into the actuator housing is kept as low as possible for this purpose to also provide functionality at critical temperatures.

Two embodiments of exhaust flap devices of the present invention are illustrated in the drawings and will be described below.

The exhaust flap devices of the present invention have a flow housing 10 which delimits an exhaust duct 12. A flap body 14 is arranged in the exhaust duct 12, via which flap body 14 the flow cross section of the exhaust duct 12 can be controlled by turning the flap body 14 in the exhaust gas duct 12.

The flap body 14 is fastened on a shaft 16 that protrudes through the flow housing 10 into the exhaust duct 12 for this purpose. An output gear 18 is fastened on the shaft 16 at the end opposite the flap body 14, the output gear 18 being part of a gearing 20 which is designed as a spur gearing. This gearing 20 is driven by an electric motor 22, the electric motor 22 being energized in an appropriate manner. An input pinion 26 is fastened on an output shaft 24 of the electric motor 22, the input pinion 26 acting as a drive element of the gearing 20 so that the rotational movement of the electric motor 22 is transmitted as a reduced movement via the gearing 20 to the shaft 16 and thus to the flap body 14.

The electric motor 22 and the gearing 20 thus serve as the actuator 28 of the exhaust flap device and are arranged in a common actuator housing 30 formed by a main housing part 32, in which the electric motor 22 and the gearing 20 are mounted, and a cover 36 closing an actuator interior 34, which cover 36 is fastened to the main housing part 32 with the interposition of a seal 38. The electric motor 22 arranged in parallel with the shaft 16 protrudes towards the flow housing 10 in order to keep the structural space as small as possible and to allow for a simple mounting of the electric motor and the gearing 20 in the main housing part 32.

The shaft 16 must be supported in a reliable manner both axially and radially and must be sealed to prevent the intrusion of exhaust gas into the actuator housing 30 and to provide a simple rotatability and positioning of the shaft 16 or of the flap body 14 in the exhaust duct 12. The electric motor 22 must at the same time be protected against excessive thermal load due to the exhaust flap device being used in the hot exhaust region.

The flow housing 10 is therefore formed with a hollow cylindrical bearing seat 40 that extends towards an annular protrusion 42 on the actuator housing 30. The protrusion 42 is followed by an annular protrusion 44 extending into the actuator interior 34 and having a smaller diameter so that a shoulder 46 is formed between the two oppositely directed protrusions 42, 44. The walls 45 of the two protrusions 42, 44 radially delimit a receiving opening 48 into which the bearing seat 40 of the flow housing 10 protrudes in the region of the outward directed protrusion 42, the axial end of the bearing seat 40 being in contact with the shoulder 46 with interposition of an axial seal 50. The outer diameter of the bearing seat 40 substantially corresponds to the inner diameter of the walls 45 of the protrusion 42 so that the wall 47 of the bearing seat 40 and the walls 45 of the protrusion 42 radially abut against each other over the entire surface.

A first bearing 52 in the form of a slide bearing is arranged in the bearing seat 40 of the flow housing 10 for the shaft 16, which first bearing 52 is made of carbon graphite and axially abuts against a shoulder 46 of the flow housing 10 defining the exhaust duct 12. The shaft 16 extends through the first bearing 52 and, beyond the protrusion 44 extending into the actuator interior 34, through the receiving opening 48. The receiving opening 48 has a cross sectional constriction so that a respective shoulder 54, 56 is formed at the opposite ends thereof in the region of the protrusion 44 extending into the actuator interior 34.

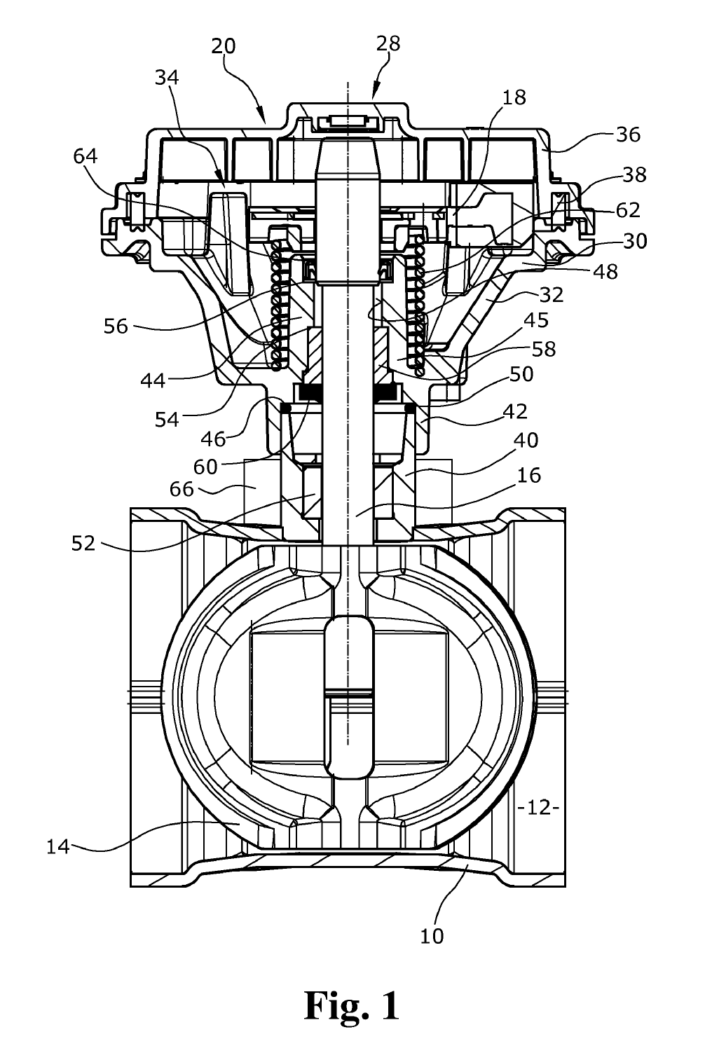

In the embodiment of the exhaust flap device illustrated in FIG. 1, a second bearing 58, which is a carbon graphite bearing, is arranged radially inside this constricted cross section so that the shaft 16 is supported at two points. The axial end of the second bearing 58 directed towards the flap body 14 protrudes slightly beyond the shoulder 54. It thereby becomes possible to press a thrust washer 60 which is fixedly mounted on the shaft 16 against the second bearing 58 by a torsion and compression spring 62 for the axial positional fixation of the shaft 16. The flow of exhaust from the exhaust duct 12 towards the second bearing 58 is thereby significantly reduced.

The spring 62 is arranged in the actuator interior 34 in a manner radially surrounding the protrusion 44 and presses against the output gear 18 fixedly arranged on the shaft 16 so that, together with the output gear 18, the shaft 16 is also loaded in the axial direction. The two end legs of the spring 62 further engage in a manner known per se behind protrusions at the actuator housing 30 and the output gear 18 (not visible in the drawings) so that the shaft 16 is pre-loaded into one direction at least when rotated out of the rest position. The shaft 16 is accordingly rotated into an emergency operating position due to the spring force if the electric motor 22 should fail.

A seal ring 64 is arranged to surround the shaft 16 at the end of the receiving opening 48 of the protrusion 44 directed into the actuator interior, which seal ring 64 axially abuts against the shoulder 56 and seals the receiving opening 48 in the direction of the actuator interior 34.

The shaft 16 is made from austenitic steel in order to avoid an overheating of the actuator 28. Austenitic steel has a thermal conductivity λ of about 15 W/mK. Thermal conduction from the exhaust duct via the shaft 16 is thereby significantly reduced. The heat still conducted towards the actuator interior 34 via the shaft 16 is dissipated first at the first bearing 52 since the first bearing 52 has a thermal conductivity λ of about 65 W/mK which is higher that the thermal conductivity of the shaft 16 and therefore serves as the first heat sink. Further heat conductance to the outside is effected since the first bearing 52 is also in radial full-surface contact with a large contact surface of the bearing seat 40 that also has a better thermal conductivity. In order to further increase the possible heat quantity that can be dissipated at this position, outward directed cooling ribs 66 are formed on the flow housing 10 in the region of the bearing seat 40 via which the heat dissipation surface is enlarged.

Further heat dissipation is achieved by a full-surface abutment of the bearing seat 40 on the protrusion 42, since the latter, like the rest of the actuator housing 30, is made of die cast aluminum having a high thermal conductivity λ of about 120 to 150 W/mK so that large quantities of heat can be dissipated thereby.

Due to its almost full-surface radial contact with the shaft 16 and the protrusion 44 of the actuator housing 30, the second bearing 58 similarly serves as an additional heat sink by which both the heat conducted directly through the shaft 16 and the heat of the exhaust gas flowing along the shaft 16 can be dissipated via the surface of the thermally conductive actuator housing 30.

Heat input into the actuator interior 34 by exhaust gas flowing along the shaft 16 is additionally prevented by the seal ring 64. A heat dissipation sheet 68 is additionally arranged at the flow housing 10 between the flow housing 10 and the section of the actuator housing 30 accommodating the electric motor 22 via which heat dissipation sheet 68 heat radiation from the exhaust duct 12 acting on the electric motor 22 is avoided.

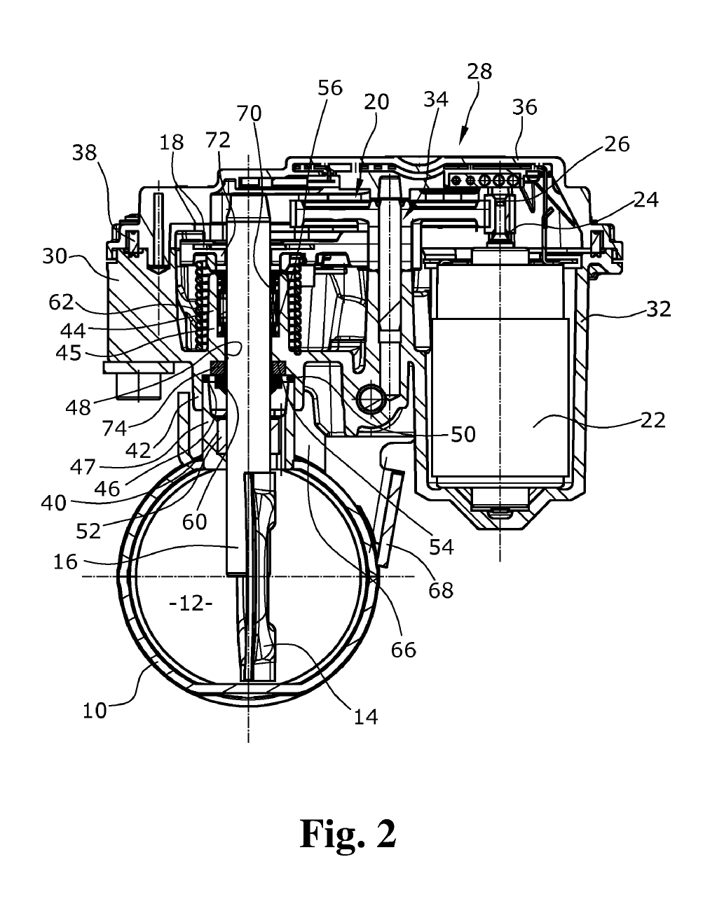

The embodiment shown in FIG. 2 differs from the above by a modified design of the supporting and sealing. Instead of using the second bearing 58 and the seal ring 64, the sealing and supporting is effected by a combination of a radial bearing in the form of a needle bearing 70 and an integrated sealing ring 72, as well as an axial bearing in the form of a bearing bushing 74.

The needle bearing 70 abuts against the shoulder 56 of the protrusion 44 directed towards the actuator interior 34, serves as a second bearing 58 for supporting the shaft 16 and, via the integrated sealing rings 72, seals the receiving opening 48 towards the actuator interior 34 so that only a small heat quantity can enter the actuator interior 34 with the exhaust gas.

The bearing bushing 74 abuts against the shoulder 54 directed towards the flow housing 10 in the region of the protrusion 44 and supports the shaft 16 axially. Similar to the sliding second bearing 58 in the first embodiment, the bearing bushing 74 protrudes beyond the shoulder 46 so that the thrust washer 60 is pre-loaded against the bearing bushing 74 by the spring 62 and rotates on the bearing bushing 74 which is in radial surface contact with the wall of the receiving opening 48 and thereby fulfills the function of the second heat sink. For this purpose, the sliding bushing, besides the full-surface contact with the well thermally conductive actuator housing 30, has a thermal conductivity that is also at least higher than the thermal conductivity of the shaft 16. A large portion of the heat conducted through the shaft 16 is accordingly also here dissipated outward into the environment via the axial and radial contact with the walls of the receiving opening.

A flap device is thus provided in which a very good outward directed heat dissipation to the environment is achieved and an intrusion of heat into the actuator interior along the one-piece shaft is reduced to an extent that the use of such an exhaust flap device in the hot exhaust region becomes possible by forming heat sinks and heat bridges.

It should be clear that the scope of protection of the present main claim is not restricted to the embodiments described herein. The shape and the structure, as well as the materials used for the components forming the heat sinks and heat bridges may in particular be modified as long as good thermal connections between the components are achieved and the thermal conductivities are provided. Reference should be had to the appended claims.

What is claimed is:

1-13. (canceled)

14. An exhaust flap device for an internal combustion engine, the exhaust gas flap comprising:
a flow housing comprising a bearing seat, the flow housing being configured to delimit an exhaust duct;
a shaft comprising a thermal conductivity of λ<17 W/mK, the shaft being configured to rotate;
a flap body attached to the shaft in the exhaust duct;
an electrical actuator comprising an electric motor and a gearing which comprises an output gear fixed on the shaft on which the flap body is arranged, the electrical actuator being configured to rotate the shaft and thereby the flap body in the exhaust duct;
an actuator housing configured to have the actuator be arranged therein;
a first bearing comprising a thermal conductivity of λ>17 W/mK, the first bearing being arranged in the bearing seat of the flow housing,
wherein,
the shaft is configured to protrude into the actuator housing, and
an inner circumference of the bearing seat corresponds to an outer circumference of the first bearing.

15. The exhaust flap device as recited in claim 14, wherein the actuator housing comprises a thermal conductivity of λ>150 W/mK.

16. The exhaust flap device as recited in claim 15, wherein the actuator housing is made of an aluminum alloy.

17. The exhaust flap device as recited in claim 14, wherein the shaft is made of an austenitic steel.

18. The exhaust flap device as recited in claim 14, wherein the first bearing is a carbon graphite bearing.

19. The exhaust flap device as recited in claim 14, wherein,
the actuator housing comprises a receiving opening which is radially delimited by walls, and
the bearing seat of the flow housing is configured to protrude into the receiving opening of the actuator housing and to radially abut against the walls.

20. The exhaust flap device as recited in claim 19, further comprising a second bearing comprising a thermal conductivity of λ>17 W/mK which is arranged in the receiving opening of the actuator housing, the second bearing being configured to support the shaft, an outer circumference of the second bearing being configured to abut against the actuator housing.

21. The exhaust flap device as recited in claim 20, further comprising a sealing ring configured to surround the shaft, the sealing ring being arranged axially in the receiving opening on a side of the second bearing which is averted from the flap body.

22. The exhaust flap device as recited in claim 20, further comprising a bearing bushing arranged in the receiving opening of the actuator housing, the bearing bushing being configured to surround the shaft and to act as an axial bearing, the bearing bushing comprising a thermal conductivity of λ>17 W/mK and an outer circumference which is configured to abut against the actuator housing.

23. The exhaust flap device as recited in claim 22, further comprising:
a radial bearing arranged in the receiving bore,
wherein,
the radial bearing is provided as a needle bearing comprising radial sealing rings,
the radial bearing is configured to surround the shaft, and
the bearing bushing is arranged axially between the flap body and the needle bearing.

24. The exhaust flap device as recited in claim 22, further comprising;
a compression spring; and
a thrust washer fastened on the shaft, the thrust washer being pre-loaded against the second bearing or the bearing bushing by the compression spring.

25. The exhaust flap device as recited in claim 14, further comprising outward directed cooling ribs formed on the flow housing in a region of the bearing seat.

26. The exhaust flap device as recited in claim 14, further comprising a heat dissipation sheet arranged between the electric motor and the flow housing.
